(19) United States
(12) Patent Application Publication
(10) Pub. No.: US 2016/0344100 A1
(43) Pub. Date: Nov. 24, 2016

(54) FRONT END CIRCUIT AND WIRELESS COMMUNICATION DEVICE

(71) Applicant: Murata Manufacturing Co., Ltd., Kyoto (JP)

(72) Inventors: Kengo ONAKA, Kyoto (JP); Hiroya TANAKA, Kyoto (JP); Hidenori OBIYA, Kyoto (JP); Yuki NAKAIKE, Kyoto (JP); Reiji NAKAJIMA, Kyoto (JP)

(21) Appl. No.: 15/160,294

(22) Filed: May 20, 2016

Related U.S. Application Data
(63) Continuation of application No. PCT/JP2014/081519, filed on Nov. 28, 2014.

(30) Foreign Application Priority Data
Nov. 28, 2013 (JP) 2013-246196

(51) Int. Cl. H01Q 5/335; H01Q 1/24

(52) U.S. Cl. CPC H01Q 5/335; H01Q 1/243

(57) ABSTRACT

A front end circuit and a wireless communication device capable of achieving matching with an antenna across a wide frequency band and capable of suppressing degradation in high-frequency characteristics caused by the influence of transmission signal harmonics is provided. A front end circuit includes a variable matching circuit connected to a low-frequency band transmission port side of a diplexer and a harmonic filter connected between the variable matching circuit and the diplexer. The harmonic filter has a pass band that overlaps with a low-frequency band-side communication band and a stop band that overlaps with a harmonic frequency of the low-frequency band-side communication band.

### BACKGROUND

### Technical Field

The present disclosure relates to a front end circuit that separates signals in communication bands within a predetermined frequency band, and to a wireless communication device that includes the same.

At present, wireless communication devices such as cellular phone terminals are configured to use multiple types of communication bands. A front end circuit is used in a wireless communication device in order to handle such a variety of communication bands using a single or a small number of antennae. The front end circuit is provided with, for example, an antenna matching circuit for ensuring matching with an antenna, and a separator circuit that separates signals in high-frequency communication bands and signals in low-frequency communication bands.

The antenna matching circuit has been configured to bring an antenna-side normalized impedance in a predetermined communication band, as viewed from the separator circuit side, to the vicinity of 1. In the case where circuits are matched at 50Ω, for example, the normalized impedance is obtained by dividing the impedance of the circuit in question by 50Ω.

However, when an antenna in a wireless communication device is near a human body or the like, the normalized impedance in the predetermined communication band can shift away from the vicinity of 1, making matching with the front end circuit difficult. Meanwhile, because wireless communication devices now handle a range of multiple communication bands, it has become difficult to set the normalized impedance of an antenna to near 1 in all of the necessary communication bands. Furthermore, the development of carrier aggregation techniques that use multiple communication bands at different frequencies simultaneously has given rise to demand for the normalized impedance in an antenna to be near 1 in each of multiple communication bands at mutually distant frequencies.

When the antenna-side normalized impedance shifts away from the vicinity of 1, the transmission signal experiences an increased amount of reflection in the antenna, the antenna matching circuit, and the like, and the reflected signal returns to a power amplifier. This produces distortion in the transmission signal in the power amplifier, which in turn causes the transmission signal to degrade, produces abnormal oscillation in the power amplifier, damages the power amplifier, or the like. The reflected signal can also leak to the reception circuit side and cause a degradation in reception sensitivity.

In light of this, an antenna tuner has been configured by providing the antenna matching circuit with a control element such as a variable capacitor and controlling the antenna-side (antenna tuner-side) normalized impedance to the vicinity of 1 (see Patent Documents 1 and 2, for example). The control element such as the variable capacitor in the antenna tuner is typically constituted of an active element including a semiconductor circuit or the like.
Patent Document 1: Japanese Unexamined Patent Application Publication No. 2013-168790
Patent Document 2: Japanese Unexamined Patent Application Publication No. 2000-286924

### BRIEF SUMMARY

However, there is a problem in that the nonlinearity of an active element distorts signals, and antenna tuners having active elements have been sources of harmonics of the transmission signals. Furthermore, in a front end circuit that separates low frequency-band signals and high frequency-band signals, harmonics of low frequency-band transmission signals have overlapped with high-frequency communication bands. For example, in LTE, transmission signals in Band 17, which is a comparatively low-frequency band, are in a frequency band of 704 MHz to 716 MHz, and a third-order harmonic thereof thus corresponds to 2112 MHz to 2148 MHz. However, this third-order harmonic frequency band overlaps with the frequency band of reception signals in the comparatively high-frequency Band 4, which is from 2110 MHz to 2155 MHz. In such a case, harmonics produced in the antenna tuner can leak to a high frequency band-side reception circuit and cause degradation in high-frequency characteristics such as reception sensitivity and the like.

Accordingly, the present disclosure provides a front end circuit and a wireless communication device capable of achieving matching with an antenna across a wide frequency band and capable of suppressing degradation in high-frequency characteristics caused by the influence of transmission signal harmonics.

A front end circuit according to this disclosure has a first frequency band-side input/output port that inputs and outputs signals of a communication band included in a first frequency band, and an antenna port that inputs and outputs signals of the communication band included in the first frequency band. The front end circuit includes a first frequency band-side filter circuit that is connected to the antenna port and has a pass band that overlaps with the communication band included in the first frequency band, and a variable matching circuit, having an active element, connected to the first frequency band-side input/output port side of the first frequency band-side filter circuit. By controlling an impedance of the variable matching circuit, a front end circuit-side normalized impedance can be set to an appropriate impedance and matching can be achieved between an antenna and the front end circuit across a wide frequency band even if an antenna-side normalized impedance has shifted away from the vicinity of 1 due to a human body or the like being close to the antenna.

Furthermore, in the front end circuit according to this disclosure, a stop band of the first frequency band-side filter circuit overlaps with a harmonic frequency of the communication band included in the first frequency band. Accordingly, even if a harmonic that causes signal distortion has been produced by the active element of the variable matching circuit, that harmonic is blocked by the first frequency band-side filter circuit and prevented from being transmitted from the antenna. The front end circuit according to this disclosure can further include an antenna matching circuit, constituted of a passive element, connected between the first frequency band-side filter circuit and the antenna port. By using the variable matching circuit provided near the first frequency band-side input/output port in this manner along with the antenna matching circuit provided near the antenna port, the antenna and the front end circuit are matched across a wide band. In the case where the antenna matching circuit is constituted of a passive element, the antenna matching circuit will not act as a source of harmonics even if the antenna matching circuit is provided further to the antenna port side than the first frequency band-side filter circuit. As such, the harmonics are prevented from being transmitted from the antenna.

In the front end circuit according to this disclosure, the active element can be constituted of a variable inductance element. Alternatively, the front end circuit according to this disclosure can further include a plurality of matching circuits, including a first matching circuit and a second matching circuit, having mutually-different impedances, and an active switching element that connects a matching circuit selected from the plurality of matching circuits between the first frequency band-side filter circuit and the first frequency band-side input/output port. In this case, an impedance of the front end circuit as viewed from the antenna port in a predetermined communication band becomes closer to a complex conjugate relationship with an impedance of an antenna connected to the antenna port in the case where one of the first matching circuit and the second matching circuit is selected by the active switching element than the case where the other one is selected thereby; as such, it is easier to achieve conjugate matching between the front end circuit and the antenna in the predetermined communication band.

The front end circuit according to this disclosure can include a second input/output port that inputs and outputs signals of a communication band included in a second frequency band that is on a higher frequency side than the first frequency band, and a second frequency band-side filter circuit that is connected to the antenna port, has a pass band that overlaps with the communication band included in the second frequency band, and has a stop band that overlaps with the communication band included in the first frequency band; and the first frequency band-side filter circuit can have a stop band that overlaps with the communication band included in the second frequency band. Through this, a harmonic of a signal on the first frequency band (also called a low-frequency band hereinafter) side will not leak to a reception circuit on the second frequency band (also called a high-frequency band hereinafter) side, and there will also be no degradation in high-frequency characteristics such as reception sensitivity. Meanwhile, in this case, the first frequency band-side filter circuit can include: a first filter that is connected to the antenna port, has a pass band that overlaps with the communication band included in the first frequency band, and has a stop band that overlaps with the communication band included in the second frequency band; and a second filter that is connected between the first filter and the variable matching circuit, has a pass band that overlaps with the communication band included in the first frequency band, and has a stop band that overlaps with the harmonic frequency of the communication band included in the first frequency band. Through this, a harmonic of the low-frequency band-side signal can be suppressed from leaking to a high-frequency band-side circuit even in the case where the harmonic frequency of the low-frequency side communication band does not overlap with the high-frequency side communication band.

Alternatively, the front end circuit according to this disclosure may further include a second frequency band-side input/output port that inputs and outputs signals of a communication band included in the second frequency band that is on a higher frequency side than the first frequency band, and a plurality of the antenna ports, and may have a configuration in which the first frequency band-side input/output port is connected to an antenna port, of the plurality of antenna ports, that is for a low frequency-side circuit, and the second frequency band-side input/output port is connected to an antenna port, of the plurality of antenna ports, that is for a high frequency-side circuit.

The front end circuit according to this disclosure further includes a transmission filter and a reception filter connected to the first frequency band-side port, and a transmission filter and a reception filter connected to the second frequency band-side port. In addition, a transmission/reception separator circuit connected between the transmission filter and the reception filter can be further included. Doing so increases isolation between the transmission filter and the reception filter using a small number of elements. Meanwhile, part of the variable matching circuit may be formed so as to be integrated with the transmission/reception separator circuit. In addition, the first frequency band-side filter circuit may be at least partially constituted of the active element, and may also functions as the variable matching circuit.

In the front end circuit according to this disclosure, each of the transmission filter and the reception filter can be constituted of a tunable filter having a variable-reactance active element or a selectable filter having a switch and a plurality of filters. Doing so makes it possible to handle many communication bands even with a low number of elements.

A wireless communication device according to this disclosure can include the above-described front end circuit, a proximity sensor that detects a state in which an object is near an antenna, and a control unit that controls the variable matching circuit on the basis of a detection result from the proximity sensor. Through this, changes in the impedance arising due to changes in the state of the antenna can be detected and the impedance of the front end circuit can be changed to an appropriate impedance.

A wireless communication device according to this disclosure includes the above-described front end circuit, an impedance matching detection circuit provided in the front end circuit, and a control unit that controls the variable matching circuit on the basis of a detection result from the impedance matching detection circuit. Through this as well, changes in the impedance arising due to changes in the state of the antenna can be detected and the impedance of the front end circuit can be changed to an appropriate impedance.

According to the front end circuit of this disclosure, it is possible to achieve matching with an antenna across a wide frequency band and suppress degradation in high-frequency characteristics caused by the influence of transmission signal harmonics.

### BRIEF DESCRIPTION OF THE SEVERAL VIEWS OF THE DRAWINGS

FIG. 1 is a diagram illustrating examples of impedance trajectories on a Smith chart in the case of conjugate matching between an antenna-side normalized impedance and a front end circuit-side normalized impedance.

FIG. 2 is a circuit block diagram illustrating a wireless communication device including a front end circuit according to a first embodiment.

FIG. 3 is a circuit block diagram illustrating a wireless communication device including a front end circuit according to a second embodiment.

FIGS. 4A-4D are diagrams illustrating examples of impedances and reflection characteristics as viewed from respective elements of the wireless communication device according to the first embodiment.

FIGS. 5A and 5B are diagrams illustrating examples of impedances and reflection characteristics as viewed from respective elements of the wireless communication device according to the first embodiment.

FIG. 6 is a circuit block diagram illustrating a wireless communication device including a front end circuit according to a third embodiment.

FIG. 7 is a circuit block diagram illustrating a wireless communication device including a front end circuit according to a fourth embodiment.

FIG. 8 is a circuit block diagram illustrating a wireless communication device including a front end circuit according to a fifth embodiment.

FIG. 9 is a circuit block diagram illustrating a wireless communication device including a front end circuit according to a sixth embodiment.

FIG. 10 is a circuit block diagram illustrating a wireless communication device including a front end circuit according to a seventh embodiment.

FIG. 11 is a circuit block diagram illustrating a wireless communication device including a front end circuit according to an eighth embodiment.

### DETAILED DESCRIPTION

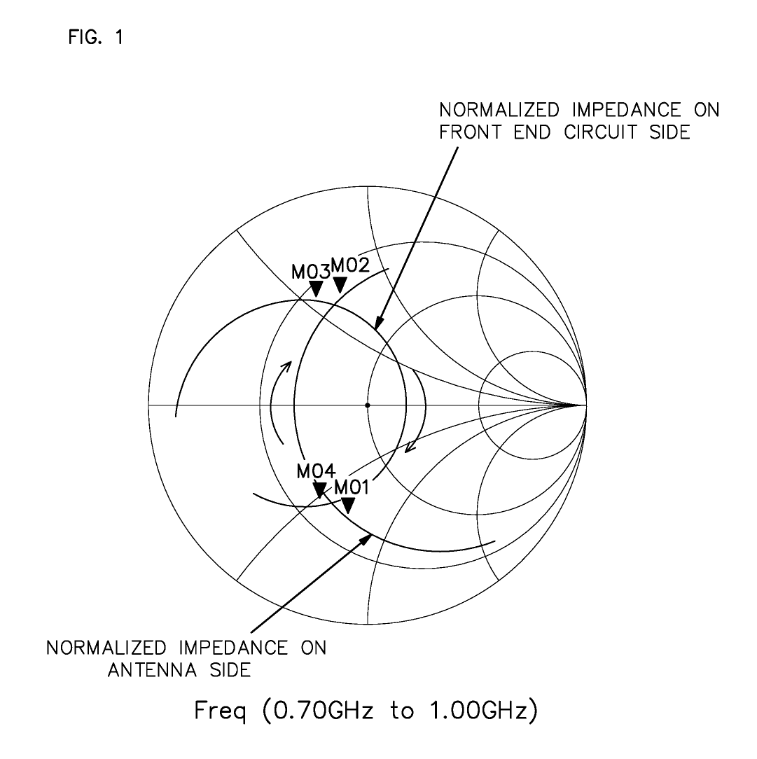

Conjugate matching will be described first. FIG. 1 is a diagram illustrating examples of the trajectory of an antenna-side normalized impedance and the trajectory of a front end circuit-side normalized impedance on a Smith chart. As the frequency increases, the antenna-side normalized impedance and the front end circuit-side normalized impedance move in the clockwise direction around a point on the Smith chart corresponding to a normalized impedance of 1 (the center of the Smith chart). The antenna-side normalized impedance and the front end circuit-side normalized impedance are in positions, in a predetermined communication band on a low-frequency band side and a predetermined communication band on a high-frequency band side respectively, where the imaginary parts thereof have opposite signs, and are close to being in a complex conjugate relationship. Matching between impedances having real parts and imaginary parts in this manner is called conjugate matching. In a state of conjugate matching, reflection of the transmission signal can be suppressed at the antenna and degradation in the transmission signal characteristics, degradation in the reception sensitivity, and so on can be prevented, even if the antenna impedance has an imaginary part; thus matching can be achieved between the antenna and the front end circuit across a wide frequency range even if the normalized impedance of the antenna has shifted away from the vicinity of 1 due to a human body or the like being near.

Several embodiments for carrying out the present disclosure will be described hereinafter with reference to the drawings, using several specific examples. Corresponding elements in the drawings are given the same reference numerals. It goes without saying that the embodiments are merely examples, and that configurations described in different embodiments can replace each other or be combined as well.

### First Embodiment

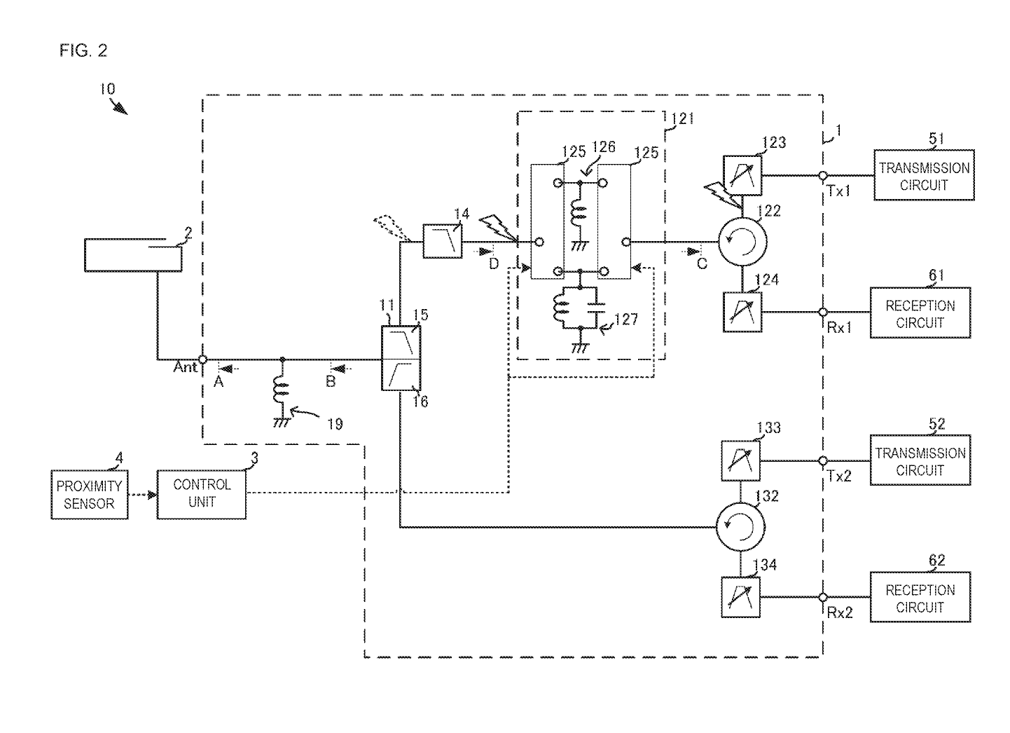

FIG. 2 is a circuit block diagram illustrating a front end circuit and a wireless communication device according to a first embodiment. A wireless communication device 10 according to the present embodiment transmits and receives using a plurality of communication bands included in a first frequency band (a low-frequency band) and a plurality of communication bands included in a second frequency band (a high-frequency band). In the case of LTE, for example, a low-frequency band-side communication band is a communication band of approximately 1 GHz or lower. In the case of LTE, for example, a high-frequency band-side communication band is a communication band of approximately 1.4 GHz or higher.

The wireless communication device 10 includes a front end circuit 1, an antenna 2, a control unit 3, a proximity sensor 4, transmission circuits 51 and 52, and reception circuits 61 and 62.

The front end circuit 1 transmits and receives in each communication band through the antenna 2. To that end, the front end circuit 1 includes a transmission port Tx1 and a reception port Rx1 as first frequency band-side input/output ports (low-frequency band-side input/output ports), a transmission port Tx2 and a reception port Rx2 as second frequency band-side input/output ports (high-frequency band-side input/output ports), and an antenna port Ant. The transmission port Tx1 is connected to the transmission circuit 51. The reception port Rx1 is connected to the reception circuit 61. The transmission port Tx2 is connected to the transmission circuit 52. The reception port Rx2 is connected to the reception circuit 62. The antenna port Ant is connected to the antenna 2.

The transmission circuit 51 handles transmission signals in a plurality of low-frequency communication bands, and outputs the transmission signals to the front end circuit 1 through the transmission port Tx1. The reception circuit 61 handles reception signals in a plurality of low-frequency communication bands, and receives the reception signals outputted by the front end circuit 1 through the reception port Rx1. The transmission circuit 52 handles transmission signals in a plurality of high-frequency communication bands, and outputs the transmission signals to the front end circuit 1 through the transmission port Tx2. The reception circuit 62 handles reception signals in a plurality of high-frequency communication bands, and receives the reception signals outputted by the front end circuit 1 through the reception port Rx2. The antenna 2 transmits transmission signals outputted by the front end circuit 1 through the antenna port Ant, and outputs received reception signals to the front end circuit 1 through the antenna port Ant.

The front end circuit 1 has a diplexer 11, a variable matching circuit 121, circulators 122 and 132, transmission filters 123 and 133, reception filters 124 and 134, a harmonic filter 14, and an antenna matching circuit 19 as internal elements.

The antenna matching circuit 19 is provided so as to be connected to the antenna port Ant within the front end circuit 1. The antenna matching circuit 19 is constituted only of one or more passive reactance elements.

The diplexer 11 is connected to the antenna port Ant through the antenna matching circuit 19 within the front end circuit 1. The diplexer 11 has a low pass filter 15 and a high pass filter 16.

The harmonic filter 14, the variable matching circuit 121, the circulator 122, the transmission filter 123, and the reception filter 124 are connected to the low pass filter 15 side of the diplexer 11. The low pass filter 15 and the harmonic filter 14 constitute a first frequency band (low-frequency band) side filter circuit. Specifically, the low pass filter 15 is connected to the harmonic filter 14. The low pass filter 15 has frequency characteristics allowing transmission signals and reception signals in the plurality of low-frequency communication bands to pass while blocking transmission signals and reception signals in the plurality of high-frequency communication bands between the harmonic filter 14 and the antenna port Ant.

One end of the harmonic filter 14 is connected to the low pass filter 15 of the diplexer 11, and another end is connected to the variable matching circuit 121. The harmonic filter 14 is, for example, a π type (C-L-C type) low pass filter having a predetermined number of stages, and has frequency characteristics allowing transmission signals and reception signals in the plurality of low-frequency communication bands to pass while blocking harmonics in the plurality of low-frequency communication bands between the variable matching circuit 121 and the diplexer 11.

One end of the variable matching circuit 121 is connected to the harmonic filter 14, and another end is connected to the circulator 122. The impedance of the variable matching circuit 121 is variable and is controlled by the control unit 3.

The variable matching circuit 121 has an active switch element 125 and matching circuits 126 and 127. The active switch element 125 selects one of the matching circuits 126 and 127 and connects that circuit to the signal path, and is controlled by the control unit 3. The matching circuits 126 and 127 are each constituted of passive reactance elements, and have mutually-different impedances.

The circulator 122 has three connection terminals, each of which is connected to one of the transmission filter 123, the reception filter 124, and the variable matching circuit 121. Signal propagation directions among the three connection terminals of the circulator 122 are irreversible. Accordingly, the transmission filter 123, the reception filter 124, and the variable matching circuit 121 are connected to the three connection terminals of the circulator 122 so that a signal passes from the transmission filter 123 to the variable matching circuit 121 and a signal passes from the variable matching circuit 121 to the reception filter 124. In other words, the circulator 122 functions as a transmission/reception separator circuit that separates transmission signals and reception signals.

One end of the transmission filter 123 is connected to the circulator 122, and another end is connected to the transmission port Tx1 within the front end circuit 1. One end of the reception filter 124 is connected to the circulator 122, and another end is connected to the reception port Rx1 within the front end circuit 1. The transmission filter 123 and the reception filter 124 include variable-reactance active elements such as digital tuning capacitors (DTC) or the like, and are band pass filters whose pass bands and stop bands are variable. The pass bands and stop bands of the transmission filter 123 and the reception filter 124 are controlled by the control unit 3.

The circulator 132, the transmission filter 133, and the reception filter 134 are connected to the high pass filter 16 side of the diplexer 11. The high pass filter 16 constitutes a second frequency band (high-frequency band) side filter circuit. Specifically, the high pass filter 16 is connected to the circulator 132. The high pass filter 16 has frequency characteristics allowing transmission signals and reception signals in the plurality of high-frequency communication bands to pass while blocking transmission signals and reception signals in the plurality of low-frequency communication bands between the circulator 132 and the antenna port Ant.

The circulator 132 has three connection terminals, each of which is connected to one of the transmission filter 133, the reception filter 134, and the diplexer 11. Signal propagation directions among the three connection terminals of the circulator 132 are irreversible. Accordingly, the transmission filter 133, the reception filter 134, and the diplexer 11 are connected to the three connection terminals of the circulator 132 so that a signal passes from the transmission filter 133 to the diplexer 11 and a signal passes from the diplexer 11 to the reception filter 134.

One end of the transmission filter 133 is connected to the circulator 132, and another end is connected to the transmission port Tx2 within the front end circuit 1. One end of the reception filter 134 is connected to the circulator 132, and another end is connected to the reception port Rx2 within the front end circuit 1. The transmission filter 133 and the reception filter 134 include variable-reactance active elements such as digital tuning capacitors (DTC) or the like, and are band pass filters whose pass bands and stop bands are variable. The pass bands and stop bands of the transmission filter 133 and the reception filter 134 are controlled by the control unit 3.

The proximity sensor 4 detects an amount of reflected infrared light, a capacitance value, or the like that changes in response to a housing (not shown) of the wireless communication device 10 approaching the hand, head, or the like of a person holding the housing.

The control unit 3 determines whether the antenna is in an antenna proximate state or an antenna non-proximate state on the basis of a change in a detection value from the proximity sensor 4. “Antenna proximate state” refers to a state where the hand, head, or the like of a person holding the housing is near the antenna 2. “Antenna non-proximate state” refers to a state where the hand, head, or the like of a person holding the housing is not near the antenna 2.

The control unit 3 controls the variable matching circuit 121 of the front end circuit 1 on the basis of whether the state is the antenna proximate state or the antenna non-proximate state. Through this, the control unit 3 changes the impedance of the front end circuit 1 to an appropriate impedance.

In the front end circuit 1 configured in this manner, the active switch element 125 of the variable matching circuit 121 and the variable-reactance active elements of the transmission filter 123, act as sources of low-frequency band-side transmission signal harmonics. Accordingly, low-frequency band-side transmission signal harmonics are outputted to the antenna port Ant side from the active switch element 125. For example, in the case where the low-frequency band-side transmission signal is in Band 17 (Tx 704-716 MHz), a second-order harmonic (1408-1432 MHz), a third-order harmonic (2112-2148 MHz), or the like thereof is outputted.

However, the harmonic filter 14, which has characteristics of blocking low-frequency band-side transmission signal harmonics, is provided on the antenna port Ant side of the active switch element 125, and thus low-frequency band-side transmission signal harmonics are blocked by the harmonic filter 14.

On the other hand, there is no active element to act as a source of low-frequency band-side transmission signal harmonics provided downstream from the harmonic filter 14 provided for the low-frequency band-side transmission signals, or in other words, on the diplexer 11, antenna matching circuit 19, and antenna 2 side, and thus low-frequency band-side transmission signal harmonics will not be produced downstream from the harmonic filter 14. Accordingly, low-frequency band-side transmission signal harmonics can be prevented from being transmitted from the antenna 2, leaking from the high pass filter 16 of the diplexer 11 to the transmission port Tx2 or reception port Rx2 side, and so on, which in turn makes it possible to prevent a degradation in high-frequency characteristics such as a drop in reception sensitivity on the high-frequency band side.

Note that the harmonic filter 14 and the low pass filter 15 of the diplexer 11 constitute the low-frequency band-side filter circuit. The low pass filter 15 corresponds to a first filter of the frequency band-side filter circuit. Meanwhile, the harmonic filter 14 corresponds to a second filter of the frequency band-side filter circuit. Likewise, the high pass filter 16 of the diplexer 11 constitutes the high-frequency band-side filter circuit.

Meanwhile, in the wireless communication device 10, the control unit 3 controls the variable matching circuit 121 to switch between connecting the matching circuit 126 and the matching circuit 127 depending on whether the state has been determined to be the antenna proximate state or the antenna non-proximate state on the basis of the output of the proximity sensor 4.

For example, in the case where the state is determined to the antenna non-proximate state, the variable matching circuit 121 is controlled to connect the matching circuit 126, whereas in the case where the state is determined to be the antenna proximate state, the variable matching circuit 121 is controlled to connect the matching circuit 127. Through this, the impedance of the front end circuit 1 as viewed from the antenna 2 side (called a front end circuit-side impedance hereinafter), in the case where the matching circuit 126 is connected, can be matched to the antenna-side impedance in the antenna non-proximate state, in a predetermined frequency band. Meanwhile, the front end circuit-side impedance, in the case where the matching circuit 127 is connected, can be matched to the antenna-side impedance in the antenna proximate state, in a predetermined frequency band.

Then, one of the front end circuit-side impedance in the case where the matching circuit 126 is connected and the front end circuit-side impedance in the case where the matching circuit 127 is connected is set to be close to a complex conjugate relationship with the antenna-side impedance that has a real part and an imaginary part shifted away from the vicinity of 50Ω in the predetermined frequency band. Through this, conjugate matching can be achieved between the antenna-side impedance and the front end circuit-side impedance in a predetermined communication band, and transmission signal reflection at the antenna 2 can be suppressed.

As described above, in the wireless communication device 10 and the front end circuit 1 according to the present embodiment, switching between connecting the matching circuit 126 and connecting the matching circuit 127 makes it possible to match the front end circuit 1 and the antenna 2 across a wide frequency range; accordingly, providing the harmonic filter 14 between the variable matching circuit 121 and the diplexer 11 makes it possible to prevent transmission signal harmonics from leaking to the antenna 2 side, circuits on the high-frequency band side, and so on, even in the case where the variable matching circuit 121 having an active element is provided in this manner.

In the present embodiment, the isolation between the transmission filters 123 and 133 and the reception filters 124 and 134 can be improved by providing the circulators 122 and 132 between the transmission filters 123 and 133 and the reception filters 124 and 134. However, the circulators 122 and 132 can be omitted in the case where the transmission filters 123 and 133 and the reception filters 124 and 134 have frequency characteristics where almost no signal leakage occurs therebetween, the case where only communication bands having large differences in frequencies between the transmission signals and the reception signals are used, and so on. In addition, rather than providing a variable matching circuit only in the signal path on the low-frequency band side, a variable matching circuit may be provided in the signal path on the high-frequency band side, or variable matching circuits may be provided in both the signal path on the low-frequency band side and the signal path on the high-frequency band side.

### Second Embodiment

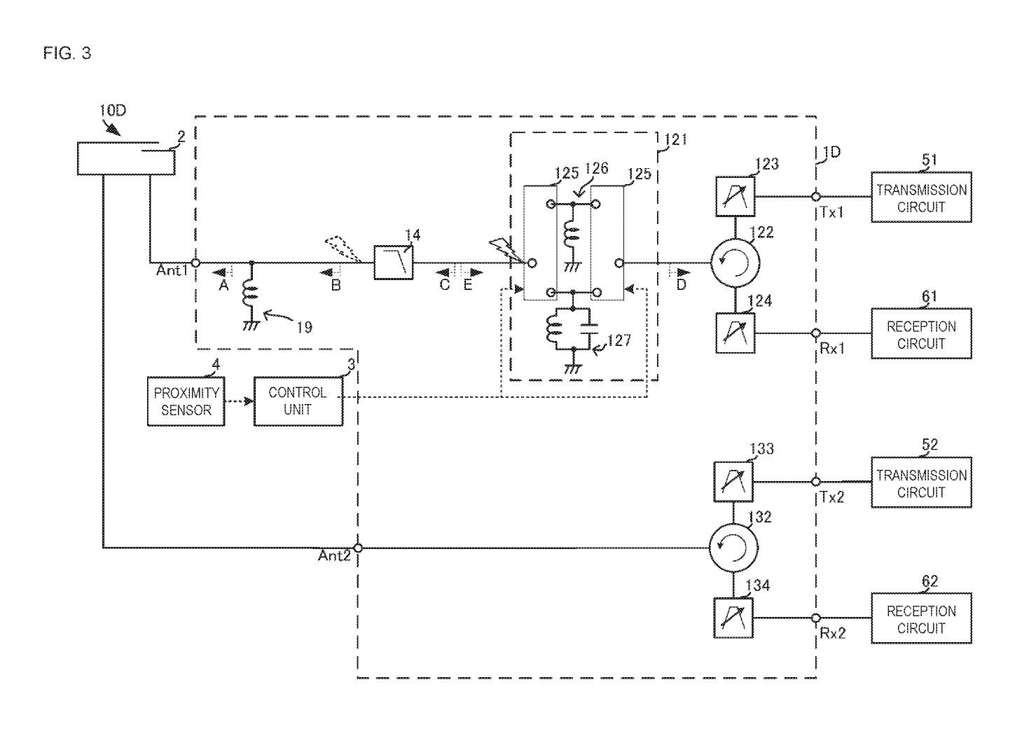

A wireless communication device 10D and a front end circuit 1D according to a second embodiment of the present disclosure will be described next. FIG. 3 is a circuit block diagram illustrating the wireless communication device 10D and the front end circuit 1D according to the present embodiment. The wireless communication device 10D and the front end circuit 1D omit the diplexer 11 described in the first embodiment, and are provided with an antenna port Ant1 for circuits on the low-frequency band side and an antenna port Ant2 for circuits on the high-frequency band side. In the front end circuit 1D, the harmonic filter 14 is connected directly to the antenna port Ant1, and the circulator 132 is connected directly to the antenna port Ant2. The antenna matching circuit 19 is provided only for the antenna port Ant1. The two power supply points, one for low frequencies and one for high frequencies, are provided for the antenna 2. The antenna 2 may be constituted of a single element, or may be split into two elements, one for low frequencies and one for high frequencies.

The wireless communication device and the front end circuit according to the present disclosure may be configured as described in the present embodiment. Although the diplexer corresponds to the high-frequency band-side filter circuit in the previous embodiment, the circulator 132 and the transmission filter 133 as well as the reception filter 134 correspond to the high-frequency band-side filter circuit in the present embodiment. Furthermore, the harmonic filter 14 corresponds to the low-frequency band-side filter circuit, instead of the diplexer as in the previous embodiment.

<<Example of Design for Conjugate Matching>>

An example of design for conjugate matching using the configuration of the present embodiment will be described next.

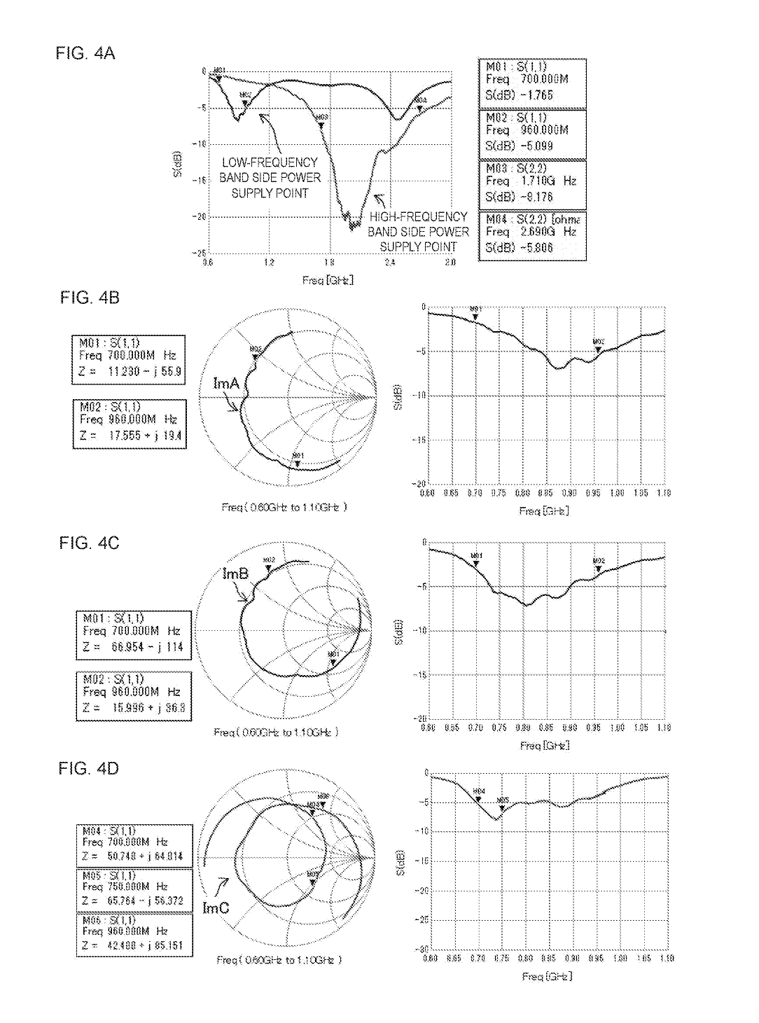

FIG. 4A is a diagram illustrating reflection characteristics (S11) of the antenna 2 alone. The antenna 2 has a power supply point to which the high-frequency band-side circuit is connected and a power supply point to which the low-frequency band-side circuit is connected. This antenna 2 is a single element, and has favorable reflection characteristics at the high-frequency band-side power supply point, with an extremely low reflection of approximately −20 dB at a peak between approximately 1710-2690 MHz (approximately 2000 MHz), but has reflection characteristics with a high amount of reflection in comparison with the high-frequency bands, of approximately −6 dB at a peak between approximately 700-960 MHz (approximately 570 MHz), at the low-frequency band-side power supply point.

FIG. 4B is a diagram illustrating the antenna 2-side reflection characteristics (S11) as viewed from a point A (see FIG. 3) in a low-frequency band (approximately 700-960 MHz) and the trajectory of an antenna-side impedance ImA on a Smith chart.

As the frequency increases, the antenna-side impedance ImA shifts in the clockwise direction around a point on the Smith chart corresponding to an impedance of 50Ω (the center of the Smith chart). The antenna-side impedance ImA is shifted greatly from the point on the Smith chart corresponding to the impedance of 50Ω, and has a real part and an imaginary part. Assuming the impedance of a power supply circuit connected to the point A is 50Ω, the antenna-side impedance ImA is very far from the impedance of the power supply circuit connected to the point A, and thus the antenna-side reflection characteristics are approximately −7 dB at the peak, and thus are not as favorable as the characteristics on the high-frequency band side.

FIG. 4C is a diagram illustrating the antenna 2-side reflection characteristics (S11) as viewed from a point B (see FIG. 3) in a low-frequency band (approximately 700-960 MHz) and the trajectory of an antenna-side impedance ImB on a Smith chart. It is assumed here that the antenna matching circuit 19 and a transmission line (15 mm) are connected between the point A and the point B. The influence of the diplexer 11 described in the first embodiment on the antenna-side reflection characteristics and the antenna-side impedance is the same as the transmission line.

As the frequency increases, the antenna-side impedance ImB shifts in the clockwise direction around a point on the Smith chart corresponding to an impedance of 50Ω (the center of the Smith chart). Compared to the trajectory of the antenna-side impedance ImA illustrated in FIG. 4B, the trajectory of the antenna-side impedance ImB is shifted so as to rotate counter-clockwise around the center of the Smith chart, due to the transmission line. The trajectory is also shifted toward the center of the Smith chart, due to the antenna matching circuit. Accordingly, although the antenna-side impedance ImB also has a real part and an imaginary part, the reflection characteristics of the antenna-side impedance ImB are closer to the point on the Smith chart corresponding to an impedance of 50Ω, and reflection has decreased across a comparatively wide frequency range, as compared to the reflection characteristics of the antenna-side impedance ImA illustrated in FIG. 4B.

FIG. 4D is a diagram illustrating the antenna 2-side reflection characteristics (S11) as viewed from a point C (see FIG. 3) in a low-frequency band (approximately 700-960 MHz) and the trajectory of an impedance ImC on a Smith chart. It is assumed here that the harmonic filter 14 is connected between the point B and the point C.

Although transmission signal harmonics can be prevented from leaking to the antenna side, the high-frequency band-side circuits, and so on as described above by providing the harmonic filter 14, the antenna-side impedance ImC makes approximately two rotations in the clockwise direction around the point corresponding to an impedance of 50Ω (the center of the Smith chart) from the vicinity of an open position on the Smith chart as the frequency increases. Accordingly, although the antenna-side impedance ImC also has a real part and an imaginary part, the reflection characteristics of the antenna-side impedance ImC are shifted away from the point on the Smith chart corresponding to an impedance of 50Ω, with increased reflection, and are thus degraded compared to the reflection characteristics of the antenna-side impedance ImB illustrated in FIG. 4C.

Accordingly, the present disclosure connects the variable matching circuit 121 to the circulator 122-side circuit in order to achieve conjugate matching between the circulator 122-side circuit and the antenna-side circuit.

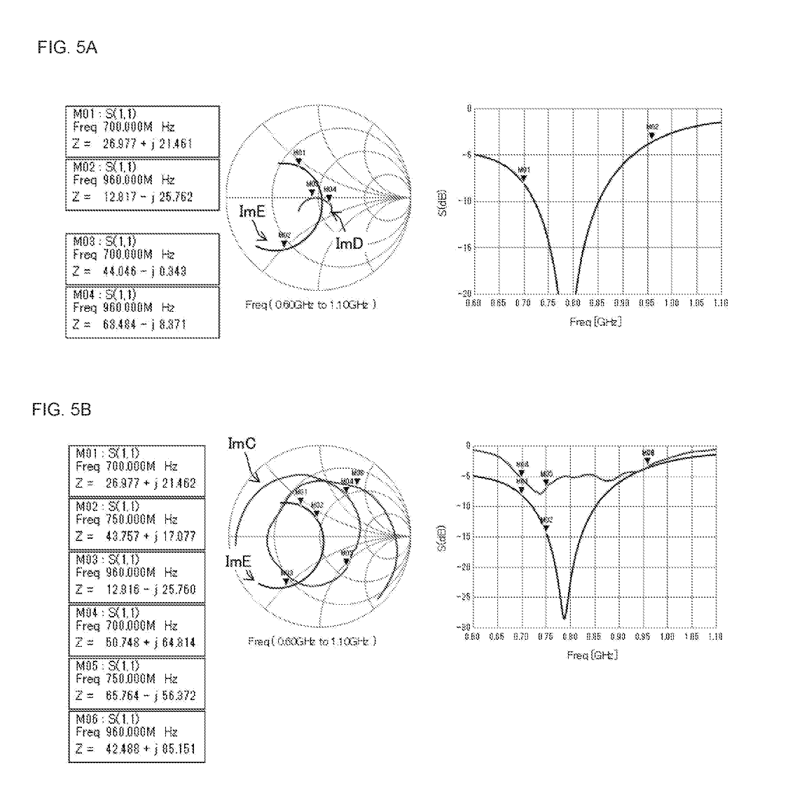

FIG. 5A is a diagram illustrating circulator 122-side reflection characteristics (S11) as viewed from a point E (see FIG. 3) in a low-frequency band (approximately 700-960 MHz) and the trajectories of impedances ImD and ImE on a Smith chart as viewed from points D and E (see FIG. 3). This assumes a case where the transmission filter 123 and the reception filter 124 are not connected to the circulator 122 but are instead terminated at 50Ω. It is furthermore assumed that the matching circuit 127 of the variable matching circuit 121 is connected between the point D and the point E.

As the frequency increases, the impedance ImD of the circulator 122 shifts slightly near the point on the Smith chart corresponding almost exactly to 50Ω. On the other hand, the impedance ImE as viewed from the point E in FIG. 3 is located near the point on the Smith chart corresponding to 50Ω at the peak (a frequency of approximately 780 MHz), but shifts away from the point on the Smith chart corresponding to 50Ω on both the low-frequency and high-frequency sides of the peak, and has a real part and an imaginary part.

FIG. 5B is a diagram comparing the antenna-side impedance ImC as viewed from the point C with the impedance ImE as viewed from the point E.

While the impedance ImE passes near the point on the Smith chart corresponding to 50Ω, the antenna-side impedance ImC is greatly shifted from the point on the Smith chart corresponding to 50Ω. However, in a frequency band near 750 MHz, the impedance ImE and the antenna-side impedance ImC both have real parts near 50Ω, with the positive/negative signs of the imaginary parts thereof being opposite. In other words, the impedance ImE and the antenna-side impedance ImC are near a complex conjugate relationship in a frequency band near 750 MHz.

As such, in the case of the design example described here, conjugate matching can be achieved between the antenna 2 and the front end circuit 1 by using the variable matching circuit 121 (the matching circuit 127) in a frequency band near 750 MHz from the low-frequency band used by the front end circuit (approximately 700-960 MHz), and transmission signals in communication bands that use the frequency band near 750 MHz can be transmitted from the antenna 2 with a small amount of reflection.

### Third Embodiment

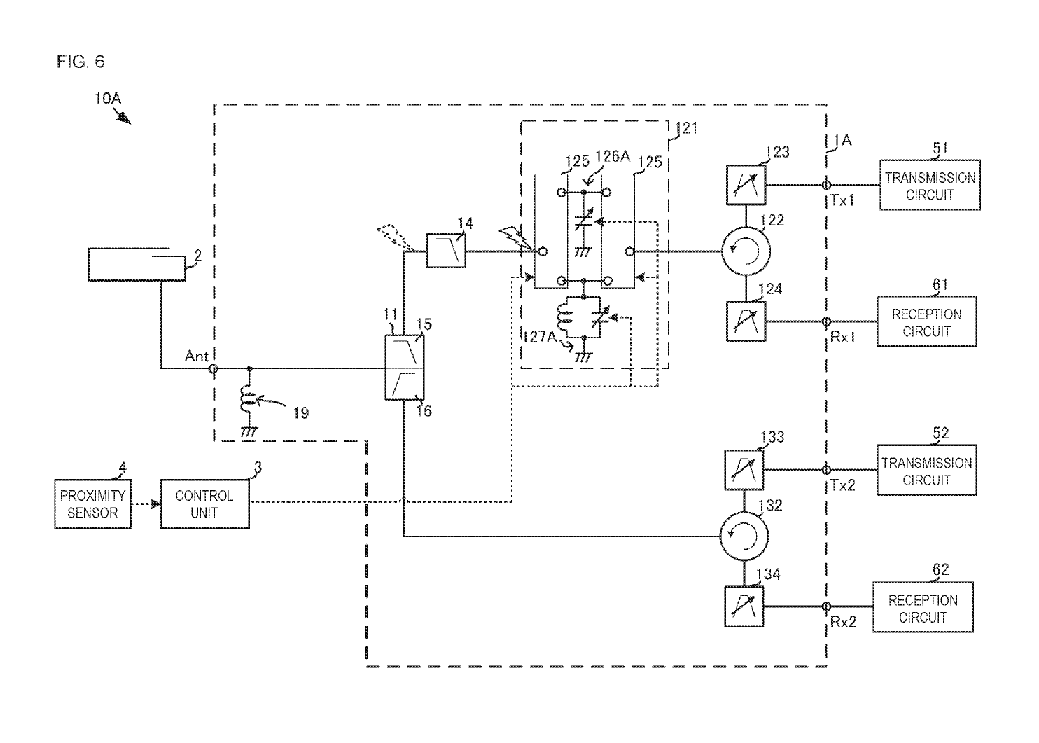

A wireless communication device 10A and a front end circuit 1A according to a third embodiment of the present disclosure will be described next. FIG. 6 is a circuit block diagram illustrating the wireless communication device 10A and the front end circuit 1A according to the present embodiment. The wireless communication device 10A and the front end circuit 1A include matching circuits 126A and 127A instead of the matching circuits 126 and 127 described in the first embodiment. The matching circuits 126A and 127A are variable impedance circuits having variable-reactance active elements such as digital tuning capacitors (DTC).

When the current state is determined to be the antenna non-proximate state, the control unit 3 controls the variable matching circuit 121 to cause the active switch element 125 to connect the matching circuit 126A to the signal path. Meanwhile, when the current state is determined to be the antenna proximate state, the control unit 3 controls the variable matching circuit 121 to cause the active switch element 125 to connect the matching circuit 127A to the signal path.

The matching circuit 126A is a matching circuit that, when connected to the signal path, conjugate-matches the front end circuit-side impedance to the antenna-side impedance in the antenna non-proximate state for a predetermined low-frequency band and a predetermined high-frequency band. The matching circuit 126A has its variable-reactance active element controlled by the control unit 3 in accordance with the communication band that is used, which makes it possible to change the corresponding communication band.

The matching circuit 127A is a matching circuit that, when connected to the signal path, conjugate-matches the front end circuit-side impedance to the antenna-side impedance in the antenna proximate state for a predetermined low-frequency band and a predetermined high-frequency band. The matching circuit 127A has its variable-reactance active element controlled by the control unit 3 in accordance with the communication band that is used, which makes it possible to change the corresponding communication band.

The wireless communication device and the front end circuit according to the present disclosure may be configured as described in the present embodiment. Note that the impedances of both the matching circuits 126A and 127A may be variable, or only the impedance of one may be variable. In addition, although here the connections of the matching circuit 126A and the matching circuit 127A are switched by the variable matching circuit 121 in accordance with changes in the antenna proximate state and the variable-reactance active elements are controlled in accordance with changes in the communication band, conversely, the variable-reactance active elements may be controlled in accordance with changes in the antenna proximate state and the connections of the matching circuit 126A and the matching circuit 127A may be switched by the variable matching circuit 121 in accordance with changes in the communication band. Furthermore, as in the present embodiment, a matching circuit may be configured using a variable-reactance active element in the configurations described above in the second embodiment as well.

### Fourth Embodiment

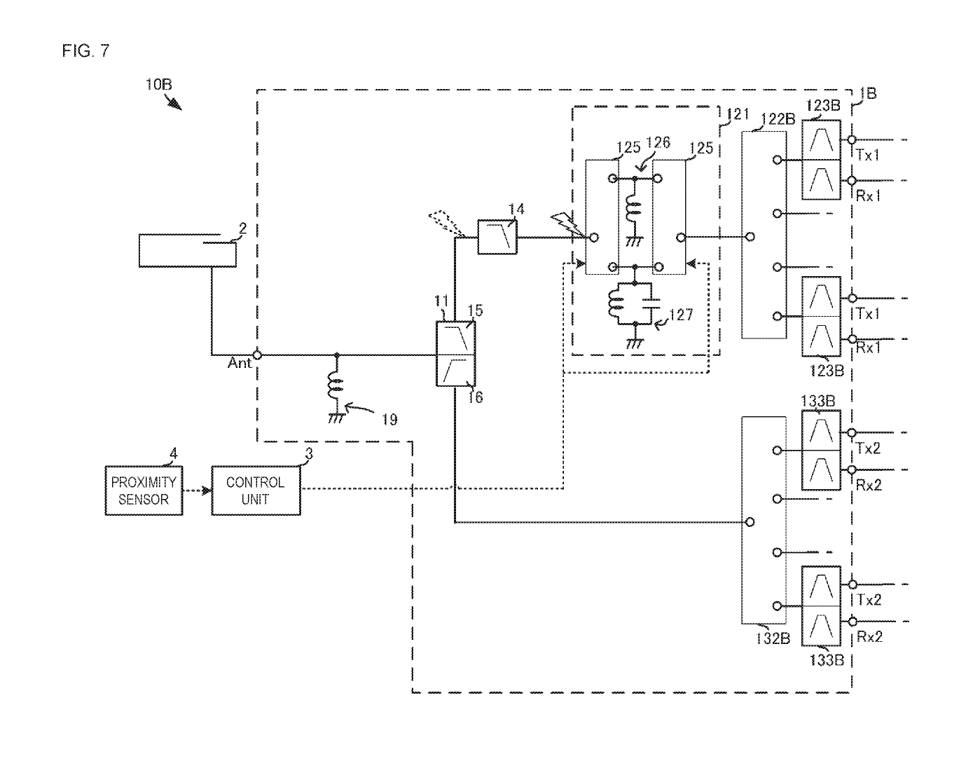

A wireless communication device 10B and a front end circuit 1B according to a fourth embodiment of the present disclosure will be described next. FIG. 7 is a circuit block diagram illustrating the wireless communication device 10B and the front end circuit 1B according to the present embodiment. The wireless communication device 10B and the front end circuit 1B have switchplexers 122B and 132B and pluralities of duplexers 123B and 133B, instead of the circulators 122 and 132 as well as the transmission filters 123 and 133 and the reception filters 124 and 134 according to the first embodiment. The plurality of duplexers 123B handle respective low-frequency communication bands, and are constituted by a transmission filter and a reception filter that take those communication bands as their pass bands. The plurality of duplexers 133B handles respective high-frequency communication bands, and is constituted by a transmission filter and a reception filter that take those communication bands as their pass bands. The switchplexer 122B handles low-frequency bands, is provided between the variable matching circuit 121 and the plurality of duplexers 123B, and selects and connects one of the duplexers 123B to the variable matching circuit 121. The switchplexer 132B handles high-frequency bands, is provided between the high pass filter 16 of the diplexer 11 and the plurality of duplexers 133B, and selects and connects one of the duplexers 133B to the high pass filter 16.

The wireless communication device and the front end circuit according to the present disclosure may be configured as described in the present embodiment. Note that as in the present embodiment, the pass bands of the transmission filter and the reception filter may be changed using switchplexers and duplexers in the configuration described above in the second embodiment and the third embodiment as well.

### Fifth Embodiment

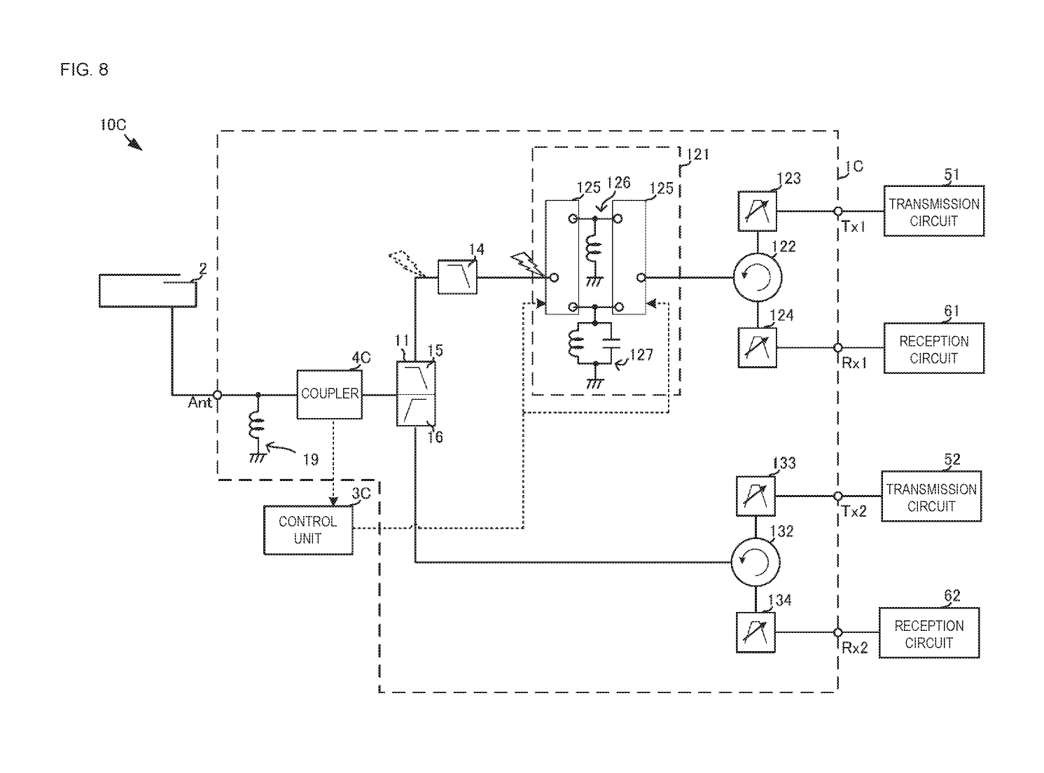

A wireless communication device 10C and a front end circuit 1C according to a fifth embodiment of the present disclosure will be described next. FIG. 8 is a circuit block diagram illustrating the wireless communication device 10C and the front end circuit 1C according to the present embodiment. The wireless communication device 10C and the front end circuit 1C include a control unit 3C and a coupler 4C instead of the control unit 3 and the proximity sensor 4 described in the first embodiment. The coupler 4C has a main line (not illustrated) connected between the front end circuit 1C and the antenna matching circuit 19, and a secondary line (not illustrated) that couples with the main line; the coupler 4C serves as an impedance matching detection circuit that obtains some of the power flowing in the main line. The control unit 3C determines whether or not a state of mismatching has occurred for the antenna 2 on the basis of the power obtained from the secondary line of the coupler 4C. For example, whether or not the voltage standing wave ratio (VSWR) is greater than or equal to a threshold is used to determine a state of mismatching. The control unit 3C controls the variable matching circuit 121 to connect the matching circuit 127 to the signal path in a state of mismatching.

The wireless communication device and the front end circuit according to the present disclosure may be configured as described in the present embodiment. Note that the position where the coupler 4C is provided may be on the antenna 2 side or on the front end circuit 1C side. Likewise, in the case where the coupler 4C is provided in the front end circuit 1C, the coupler 4C may be provided further on the antenna side than the diplexer 11, or may be provided further on the side of the circulators 122 and 132 than the diplexer 11. Furthermore, as in the present embodiment, matching control may be carried out using a signal detected by a coupler in the configurations described above in the second to fourth embodiments as well.

### Sixth Embodiment

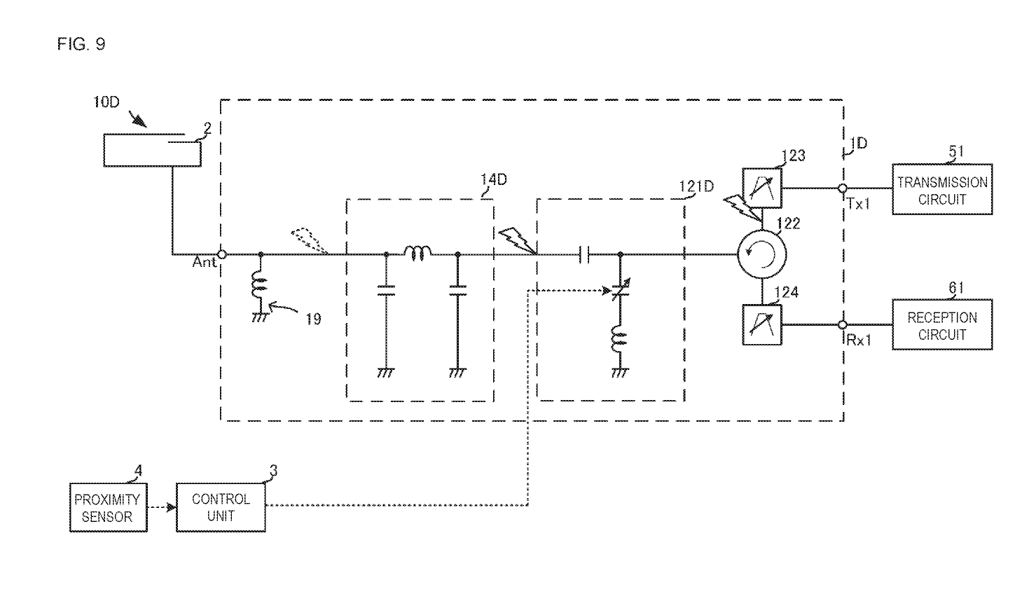

A wireless communication device 10D and a front end circuit 1D according to a sixth embodiment of the present disclosure will be described next. FIG. 9 is a circuit block diagram illustrating the wireless communication device 10D and the front end circuit 1D according to the present embodiment. The wireless communication device 10D and the front end circuit 1D have a configuration that omits the circuit elements corresponding to signals in the high-frequency side communication bands described in the first embodiment, or in other words, omits the diplexer 11, the circulator 132, the transmission filter 133, and the reception filter 134. Meanwhile, the wireless communication device 10D and the front end circuit 1D include a harmonic filter 14D and a variable matching circuit 121D instead of the circuit elements corresponding to signals in the low-frequency side communication bands described in the first embodiment, or in other words, instead of the harmonic filter 14 and the variable matching circuit 121.

Here, the harmonic filter 14D is constituted of a single-stage π type circuit, and includes a serial arm reactance element (inductor) and first and second parallel arm reactance elements (capacitors). Any desired characteristics, numbers, connection configurations, and so on may be employed for the respective reactance elements as long as the harmonic filter 14D has a circuit configuration having characteristics that take at least a low-frequency communication band as its pass band and takes a harmonic of that communication band as a stop band (low pass filter characteristics, for example). The harmonic filter 14D may have a circuit configuration in which the stated 7c type circuit is connected in multiple stages.

Meanwhile, the variable matching circuit 121D is configured as a single-stage ladder circuit, and includes a serial arm reactance element (capacitor) and a parallel arm variable reactance element (variable capacitor) and reactance element (inductor). Any desired characteristics, numbers, connection configurations, and so on may be employed for the respective reactance elements as long as the variable matching circuit 121D has a circuit configuration that includes at least a variable reactance element whose reactance can be controlled and can achieve matching between the harmonic filter 14D and the circulator 122. The variable matching circuit 121D may have a circuit configuration in which the stated ladder circuit is connected in multiple stages.

It is sufficient for the front end circuit and wireless communication device according to the present disclosure to have a filter circuit function that allows a communication band included in at least one predetermined frequency band to pass and blocks harmonics in that communication band as in the present embodiment, and a variable matching circuit function that is provided on the transmission/reception circuit side of the filter circuit and achieves matching; a circuit configuration that leaves a circuit configuration corresponding to one of a high-frequency band and a low-frequency band and omits a circuit configuration corresponding to the other of the frequency bands may be employed in the first to fifth embodiments described above as well.

### Seventh Embodiment

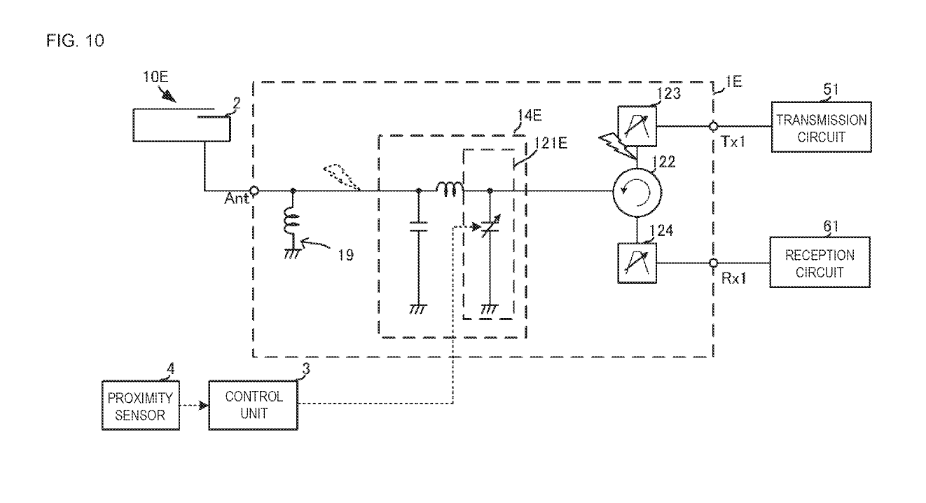

A wireless communication device 10E and a front end circuit 1E according to a seventh embodiment of the present disclosure will be described next. FIG. 10 is a circuit block diagram illustrating the wireless communication device 10E and the front end circuit 1E according to the present embodiment. In the wireless communication device 10E and the front end circuit 1E, of the various reactance elements that constitute the variable matching circuit in the sixth embodiment, the reactance elements aside from the variable reactance element are replaced with circuit elements of a filter circuit (a harmonic filter 14E). Specifically, the front end circuit 1E includes the harmonic filter 14E. The harmonic filter 14E replaces the parallel arm capacitor with a variable reactance element that functions as a variable matching circuit 121E.

The front end circuit and the wireless communication device according to the present disclosure may be configured so that part of the filter circuit functions as a variable matching circuit as in the present embodiment, and a circuit configuration that has part of the filter circuit function as a variable matching circuit may be employed in the first to sixth embodiments described above as well.

### Eighth Embodiment

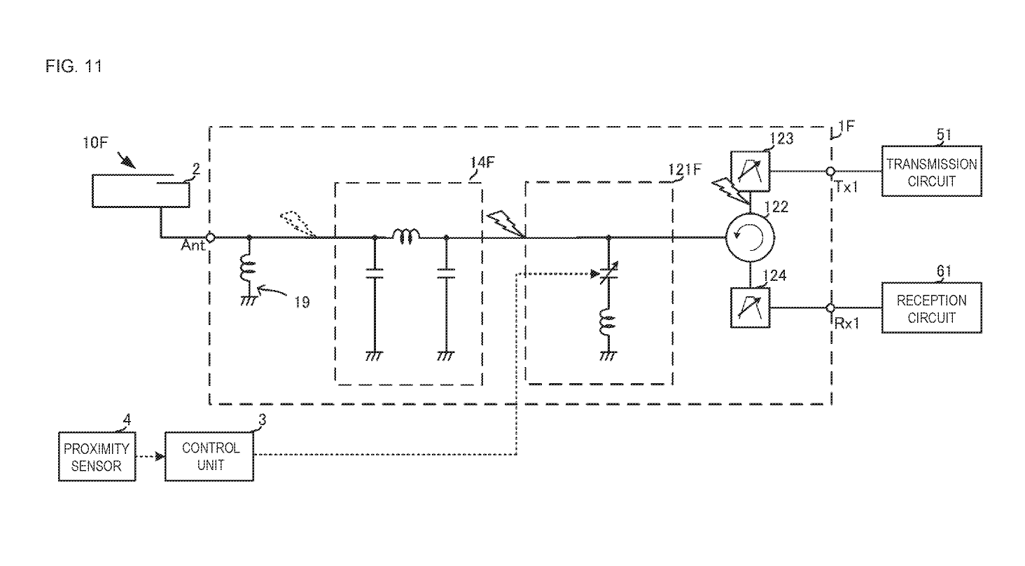

A wireless communication device 10F and a front end circuit 1F according to an eighth embodiment of the present disclosure will be described next. FIG. 11 is a circuit block diagram illustrating the wireless communication device 10F and the front end circuit 1F according to the present embodiment. In the wireless communication device 10F and the front end circuit 1F, of the various reactance elements that constitute the variable matching circuit in the sixth embodiment, some of the reactance elements aside from the variable reactance element are replaced with a reactance of the circulator 122. Specifically, the front end circuit 1F includes a variable matching circuit 121F. The variable matching circuit 121F is a circuit in which the serial arm capacitor is omitted from the configuration described in the sixth embodiment, and uses a capacitor provided in the circulator 122 instead of the stated serial arm capacitor.

The front end circuit and the wireless communication device according to the present disclosure may be configured so that some of the reactances that constitute the variable matching circuit are constituted of other circuit elements as in the present embodiment, and a circuit configuration in which some of the reactances that constitute the variable matching circuit are constituted of other circuit elements may be employed in the first to sixth embodiments described above as well.

While the present disclosure can be carried out as described in the above embodiments, the present disclosure can be realized through any embodiment as long as that embodiment falls within the scope of the appended claims. For example, a variable matching circuit may be provided in both the low-frequency band side and high-frequency band side circuits.

### REFERENCE SIGNS LIST

10 WIRELESS COMMUNICATION DEVICE
1 FRONT END CIRCUIT
11 DIPLEXER
121 VARIABLE MATCHING CIRCUIT
122, 132 CIRCULATOR
123, 133 TRANSMISSION FILTER
124, 134 RECEPTION FILTER
125 HIGH-FREQUENCY SWITCH
126, 127 MATCHING CIRCUIT
14 HARMONIC FILTER
15 LOW PASS FILTER
16 HIGH PASS FILTER
19 ANTENNA TUNER
2 ANTENNA
3 CONTROL UNIT
4 PROXIMITY SENSOR
51, 52 TRANSMISSION CIRCUIT
61, 62 RECEPTION CIRCUIT

1. A front end circuit having a first frequency band-side input/output port that inputs and outputs signals of a communication band included in a first frequency band, and an antenna port that inputs and outputs signals of the communication band included in the first frequency band, the front end circuit comprising:
a first frequency band-side filter circuit that is connected to the antenna port and has a pass band that overlaps with the communication band included in the first frequency band; and
a variable matching circuit, having an active element, connected to the first frequency band-side input/output port side of the first frequency band-side filter circuit,
wherein a stop band of the first frequency band-side filter circuit overlaps with a harmonic frequency of the communication band included in the first frequency band.

2. The front end circuit according to claim 1, further comprising:
an antenna matching circuit, constituted of a passive element, connected between the first frequency band-side filter circuit and the antenna port.

3. The front end circuit according to claim 1,
wherein the active element is constituted of a variable reactance element.

4. The front end circuit according to claim 1,
wherein the variable matching circuit includes:
a first matching circuit and a second matching circuit, the first and second matching circuits having mutually-different impedances; and
an active switching element that connects one of the first matching circuit and the second matching circuit between the first frequency band-side filter circuit and the first frequency band-side input/output port.

5. The front end circuit according to claim 4,
wherein an impedance of the front end circuit as viewed from the antenna port in a predetermined communication band is closer to a complex conjugate relationship with an impedance of an antenna connected to the antenna port when the first matching circuit is selected by the active switching element than when the second matching circuit is selected by the active switching element.

6. The front end circuit according to claim 1, further comprising:
a second input/output port that inputs and outputs signals of a communication band included in a second frequency band, the second frequency band including higher frequencies than the first frequency band; and
a second frequency band-side filter circuit that is connected to the antenna port, has a pass band that overlaps with the communication band included in the second frequency band, and has a stop band that overlaps with the communication band included in the first frequency band,
wherein the first frequency band-side filter circuit has a stop band that overlaps with the communication band included in the second frequency band.

7. The front end circuit according to claim 6,
wherein the first frequency band-side filter circuit includes:
a first filter that is connected to the antenna port, has a pass band that overlaps with the communication band included in the first frequency band, and has a stop band that overlaps with the communication band included in the second frequency band; and
a second filter that is connected between the first filter and the variable matching circuit, has a pass band that overlaps with the communication band included in the first frequency band, and has a stop band that overlaps with the harmonic frequency of the communication band included in the first frequency band.

8. The front end circuit according to claim 1, further comprising:
a second input/output port that inputs and outputs signals of a communication band included in a second frequency band, the second frequency band including higher frequencies than the first frequency band; and
a plurality of the antenna ports,
wherein the first input/output port is connected to an antenna port, of the plurality of antenna ports, that is for a low frequency-side circuit; and
the second input/output port is connected to an antenna port, of the plurality of antenna ports, that is for a high frequency-side circuit.

9. The front end circuit according to claim 6, further comprising:
an antenna connected to the antenna port, a transmission filter and a reception filter connected to the first frequency band-side input/output port, and a transmission filter and a reception filter connected to the second frequency band-side input/output port.

10. The front end circuit according to claim 9, further comprising:
a transmission/reception separator circuit connected between the transmission filter and the reception filter connected to the first frequency band-side input/output port and/or connected to the second frequency band-side input/output port.

11. The front end circuit according to claim 10,
wherein part of the variable matching circuit is formed so as to be integrated with the transmission/reception separator circuit.

12. The front end circuit according to claim 9,
wherein each of the transmission filter and the reception filter connected to the first frequency band-side input/output port and connected to the second frequency band-side input/output port is constituted of a tunable filter having a variable-reactance active element or a selectable filter having a switch and a plurality of filters.

13. The front end circuit according to claim 1,
wherein the first frequency band-side filter circuit is at least partially constituted of the active element, and also functions as the variable matching circuit.

14. A wireless communication device comprising:
the front end circuit according to claim 1;
a proximity sensor that detects proximity of an object to an antenna connected to the antenna port; and
a control unit that controls the variable matching circuit on the basis of a detection result from the proximity sensor.

15. A wireless communication device comprising:
the front end circuit according to claim 4;
a proximity sensor that detects proximity of an object to an antenna connected to the antenna port; and
a control unit that controls, based on a detection result from the proximity sensor, the active switching element to connect one of the first matching circuit and the second matching circuit between the first frequency band-side filter circuit and the first frequency band-side input/output port.

16. A wireless communication device comprising:
the front end circuit according to claim 1;
an impedance matching detection circuit provided in the front end circuit; and
a control unit that controls the variable matching circuit on the basis of a detection result from the impedance matching detection circuit.

17. A wireless communication device comprising:
the front end circuit according to claim 1;
an impedance matching detection circuit provided in the front end circuit; and
a control unit that controls, based of a detection result from the impedance matching detection circuit, the active switching element to connect one of the first matching circuit and the second matching circuit between the first frequency band-side filter circuit and the first frequency band-side input/output port.
